(19) United States
(12) Patent Application Publication
(10) Pub. No.: US 2024/0198910 A1
(43) Pub. Date: Jun. 20, 2024

(54) STEP TREAD HOLDER ASSEMBLY AND AN ASSOCIATED VEHICLE

(71) Applicant: Bruns Holding GmbH & Co. KG, Apen (DE)

(72) Inventor: Gerit Bruns, Bad Zwischenahn (DE)

(21) Appl. No.: 18/505,695

(22) Filed: Nov. 9, 2023

(30) Foreign Application Priority Data
Dec. 15, 2022 (DE) 202022107029.6

(51) Int. Cl. B60R 3/02

(52) U.S. Cl. CPC B60R 3/02

(57) ABSTRACT

A step tread holder assembly for vehicles includes a step tread which can be attached to a vehicle structure of the vehicle. The assembly also includes at least one bearing unit for attaching the step tread to the vehicle structure, the bearing unit being designed in such a way that in the event of a crash the step tread can be moved relative to the vehicle structure and/or can be partly or completely detached from the vehicle structure by a motion guiding element for influencing a path of movement of the step tread relative to the vehicle structure in the event of a crash. The bearing unit has at least one front holder which is positioned on the vehicle structure in an outer area of the vehicle, and at least one rear holder which is positioned on the vehicle structure in an inner area of the vehicle.

### CROSS-REFERENCE TO RELATED APPLICATION

This application claims priority to German Application No. 20 2022 107 029.6, filed Dec. 15, 2022. The above-mentioned patent application is incorporated herein by reference in its entirety.

### TECHNICAL FIELD

This application relates to a step tread holder assembly for a step tread for vehicles, in particular electric passenger vehicles, as well as to associated vehicles that may include such a step tread holder assembly.

### BACKGROUND

Step treads are widely used on vehicles to make it easier to get in and out of the vehicle, particularly for persons with restricted mobility. Such step treads are usually attached in the lower region of the vehicle body.

Vehicles with an electric motor also have an energy storage unit in many cases, in the form of electric batteries, or tanks for a liquid or gaseous fuel such as hydrogen, in the lower region of the vehicle body.

In the event of a crash, in particular a side-on crash, there is therefore a risk that in the case of a vehicle that has a step tread, the latter is accelerated in the direction of the energy storage unit and may damage it. It is therefore necessary to implement protective design measures that, as far as possible, prevent any damage being caused to the energy storage unit of a vehicle by the step tread in the event of a crash.

Thus, it would be desirable to provide a step tread holder assembly and a vehicle having such a step tread holder assembly which allow an enhanced level of protection for the energy storage unit of the vehicle.

### SUMMARY

These and other technical objects and problems are addressed by the embodiments provided in this disclosure and invention. In a first set of embodiments, a step tread holder assembly is provided with a step tread, a bearing unit for attaching the step tread to the vehicle structure, and a motion guiding element, with the bearing unit having at least one front holder which is positioned on the vehicle structure in an outer area of the vehicle, and the bearing unit having at least one rear holder which is positioned on the vehicle structure in an inner area of the vehicle. The step tread is thus attached at two positions. The advantage of attaching it at two positions is that the step tread can still be held by the second holder when it is completely detached at one of the positions in a crash. This prevents any uncontrolled movement of a completely detached step tread.

According to a development of the invention, the invention is characterised by a deflector for deflecting the movement of the step tread along a path of movement in the event of a crash. By the deflector, the step tread does not hit the vehicle structure in an uncontrolled manner and/or damage the energy storage unit of the vehicle.

According to another embodiment, the rear holder has a guide for deflecting the step tread. The step tread can thus be deflected in such a targeted manner, as already described in general terms above, that in the event of a crash it does not hit the energy storage unit of the vehicle and hence does not damage it.

According to another development of the invention, the guide of the rear holder are guide faces or have guide faces which are arranged obliquely relative to the horizontal in such a way that the step tread is diverted and deflected downwards and inwards relative to the vehicle structure in the event of a crash. The step tread is guided past the energy storage unit of the vehicle.

According to a development of the invention, the guide faces are arranged in an angular range between 85° and 15° relative to the horizontal, preferably in an angular range between 30° and 60° relative to the horizontal.

According to another embodiment of the invention, the bearing unit, preferably the at least one front holder, has a predetermined breaking point or a predetermined bending point, such that in the event of a crash the step tread can be moved inwards from the outside in relation to the vehicle structure, the predetermined breaking point or predetermined bending point preferably being designed in such a way that the step tread can detach itself partly or completely from the vehicle structure. Due to this partial or complete detachment, the step tread is able to move along the (guided) path in the event of a crash. If one of the holders has a predetermined bending point, this provides the advantage that the step tread can be moved into a different position in a targeted manner depending on the strength and the energy absorption capacity of the predetermined bending point, while at the same time the step tread continues to be held and does not keep moving uncontrollably and potentially put people at risk.

According to a development of the invention, the predetermined breaking point or predetermined bending point is designed as a component having a definable strength, preferably as a rod or metal sheet or bolt or screw whose strength is set in such a way that the step tread can release itself from its position when specific accelerating forces arise in the event of a crash.

According to another embodiment of the invention, the predetermined breaking point or predetermined bending point is so designed that the step tread continues to be held at least partly by the front holder after moving out of its original position. This allows the step tread to be further stabilised and to be guided more precisely.

According to another embodiment of the invention, the rear holder has a projection so as to form a bearing surface for the step tread or an attachment member connected to the step tread. In the event of a crash, the guided movement can be carried out from this basic position of the rear holder.

According to another embodiment, the projection on the rear holder forms a notch, preferably an elongate hole, which opens towards the inner side of the vehicle, and the guide faces of the guide are formed on the holder next to or adjacent to the notch or elongate hole, so as to deflect the step tread inwards and downwards in the event of a crash.

According to a development of the invention, the rear holder has a first portion extending substantially vertically downwards from the vehicle structure and a second portion extending obliquely inwards on which at least one guide face for deflecting is formed.

According to another embodiment, at least the front and/or the rear holder has a coupling member, preferably a coupling rod, which is pivotably articulated on the vehicle structure and pivotably articulated on the step tread and in the event of a crash deflects the step tread along a path of movement, also with at least a downward component of movement towards the ground, and in so doing supports the step tread.

According to a development of the invention, the coupling member is formed on the rear holder.

According to another embodiment, the front holder has a holder member which is at least partially plastically deformable and which deforms at least plastically in the event of a crash and also guides the step tread along the path of movement and continues to support the step tread in the event of a crash.

In a second set of embodiments, a vehicle is provided, in particular an electric passenger vehicle, including a vehicle structure, a drive for the vehicle, in particular an electric motor, an energy storage unit for the drive of the vehicle, in particular an electric battery or a tank for a liquid or gaseous fuel such as hydrogen or the like, and a step tread which can be attached to the vehicle structure of the vehicle. The vehicle also includes a step tread holder assembly for the step tread and at least one bearing unit for attaching the step tread to the vehicle structure. The bearing unit is so designed that in the event of a crash the step tread can be moved relative to the vehicle structure and/or can be detached partly or completely from the vehicle structure, and that the holder assembly has a motion guiding element for influencing the path of movement of the step tread relative to the vehicle structure in the event of a crash.

According to a development of the invention, the motion guiding element are designed in such a way that in the event of a crash the step tread is guided past the energy storage unit, in particular is guided along a path of movement extending at least partially underneath the energy storage unit.

According to another embodiment, the step tread holder assembly is designed according to any combination or sub-combination of the features and embodiments noted above.

### BRIEF DESCRIPTION OF THE DRAWINGS

Further advantages, features and possible applications of the present invention will be apparent from the following detailed description in connection with the drawings. The accompanying drawings, which are incorporated in and constitute a part of this specification, illustrate one of more embodiments of the invention and, together with the general description given above and the detailed description given below, explain the one or more embodiments of the invention.

FIG. 1 is a side view of a vehicle having a step tread and a step tread holder assembly according to the invention.

FIG. 2 is a sectional view showing a first embodiment of the step tread holder assembly according to the invention, in the basic position (before a crash).

FIG. 3 is a sectional view showing the embodiment shown in FIG. 2 during/after a crash.

FIG. 4 is a sectional view of a second embodiment of the step tread holder assembly according to the invention, in the basic position (before a crash).

FIG. 5 is a sectional view of the embodiment shown in FIG. 4 during/after a crash.

FIG. 6 is a sectional view of a third embodiment of the step tread holder assembly according to the invention, in the basic position (before a crash).

FIG. 7 is a sectional view of the embodiment shown in FIG. 6 during/after a crash.

### DETAILED DESCRIPTION

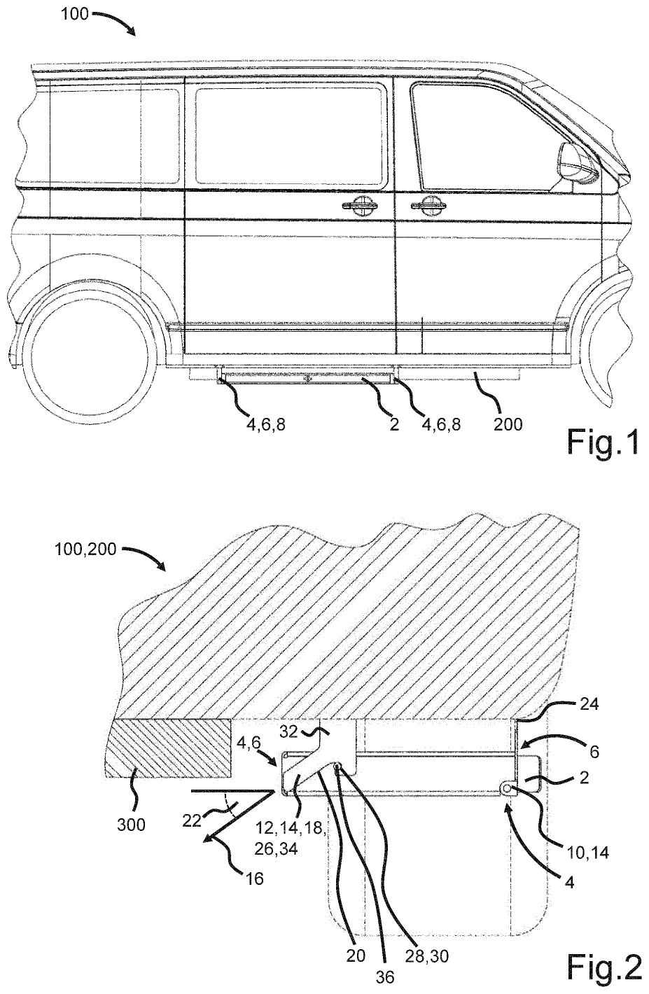

FIG. 1 shows a vehicle 100 having a vehicle structure 200 comprising a vehicle body, a step tread 2, a step tread holder assembly 4 comprising a bearing unit 6 for attaching step tread 2 to vehicle structure 200 and a motion guiding element 8 for influencing a path of movement 16 of step tread 2 relative to vehicle structure 200 in the event of a crash.

FIG. 2 shows, in a front sectional view of vehicle 100, a first embodiment of the step tread holder assembly 4 according to the invention, having a bearing unit 6, in the basic position (before a crash). The figure also shows part of an energy storage unit 300, preferably an electric battery, of vehicle 100. Holder assembly 4 has a front holder 10 which is positioned on vehicle structure 200 in an outer area of vehicle 100. Bearing unit 6 also has a rear holder 12 which is positioned on vehicle structure 200 in an inner area of vehicle 100. Holder assembly 4 also has a deflector 14 for deflecting the movement of step tread 2 along a path of movement 16 in the event of a crash. Rear holder 12 also has a guide 18 for deflecting step tread 2.

In the embodiment shown here, the guide 18 of rear holder 12 have guide faces 20 which are arranged obliquely relative to the horizontal in such a way that the step tread is diverted and deflected downwards and inwards relative to the vehicle structure in the event of a crash. The guide faces are inclined in an angular range 22 between 30° and 60° relative to the horizontal.

Front holder 10 also has a predetermined bending point 24 such that, in the event of a crash, step tread 2 can be moved inwards from the outside in relation to vehicle structure 200, the predetermined bending point 24 preferably being designed in such a way that step tread 2 can detach itself partly or completely from vehicle structure 200.

Predetermined bending point 24 is designed as a rod the strength of which is set in such a way that step tread 2 can release itself from its position when specific accelerating forces arise in the event of a crash. Predetermined bending point 24 is also designed in such a way that, after moving out of its original position, step tread 2 can continue to be held at least partly by front holder 10. The rod (with predetermined bending point 24) is preferably made of metal. It may have a circular cross-section, for example, or a rectangular cross-section and be designed in the manner of a metal sheet or plate. Predetermined bending point 24 may be embodied in an area of the rod or metal sheet or plate, for example in the upper area connected to vehicle structure 200, i.e. to the chassis of a vehicle. Alternatively, however, rod or the metal sheet or plate may also have a weak point elsewhere and bend at that point. The same also applies when it is designed as a metal sheet.

Rear holder 12 has a projection 26 such that a bearing surface 28 for step tread 2 is formed. Projection 26 on rear holder 12 forms a notch 30 which opens towards the inner side of the vehicle, and guide faces 20 of guide 18 are formed on the holder 12 next to or adjacent to notch 30, so as to deflect step tread 2 inwards and downwards in the event of a crash. Inner holder 12 also has a first portion 32 extending substantially vertically downwards from vehicle structure 200 and a second portion 34 extending obliquely inwards on which at least a guide face 20 for deflecting is formed. Via cylinder 36, which is connected to step tread 2, step tread 2 rests in notch 30 on bearing surface 28.

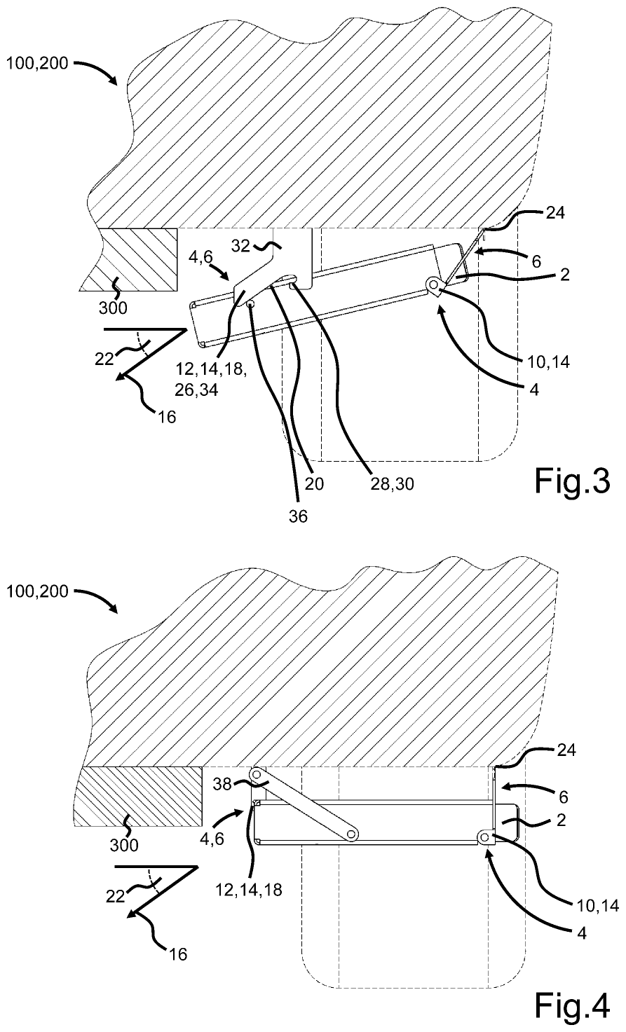

FIG. 3 shows the embodiment shown in FIG. 2 during/after a crash. Step tread 2 is moved/has been moved along path of movement 16. Due to the displacement of the step tread, cylinder 36 no longer rests on bearing surface 28, but is in contact with guide face 20. Rod 6 and thus step tread 2 have been partially detached at predetermined bending point 24; after moving out of the original position, step tread 2 continues to be partly held by front holder 10. Path of movement 16 is at an angle to the horizontal, such that step tread 2 is/has been moved past energy storage unit 300.

FIG. 4 shows a holder assembly 4 according to one embodiment, which is characterised in that the rear holder 12 has a coupling member 38 in the form of a coupling rod which is pivotably articulated on the vehicle structure 200 and pivotably articulated on the step tread 2 and in the event of a crash deflects step tread 2 along a path of movement 16, also with at least a downward component of movement towards the ground, and in so doing supports step tread 2. The predetermined bending point 24 here is likewise designed as a component having a definable strength, in the form of a rod whose strength is set in such a way that step tread 2 can release itself from its position when specific accelerating forces arise in the event of a crash. Here also, predetermined bending point 24 is designed in such a way that, after moving out of its original position, step tread 2 continues to be held at least partly by front holder 10. Holder assembly 4 is thus characterised in that front holder 10 has a holder member which is at least partly plastically deformable and which deforms at least plastically in the event of a crash and also guides step tread 2 along the path of movement and continues to support the step tread in the event of a crash.

In contrast to the embodiment in FIGS. 2 and 3, the projection 26 of the embodiment shown here is designed in such a way that it is rotatably mounted on a first portion 32 of rear holder 12. Projection 26 forms a notch 30 which opens towards the outer side of the vehicle and has a bearing surface 28 on which step tread 2 rests.

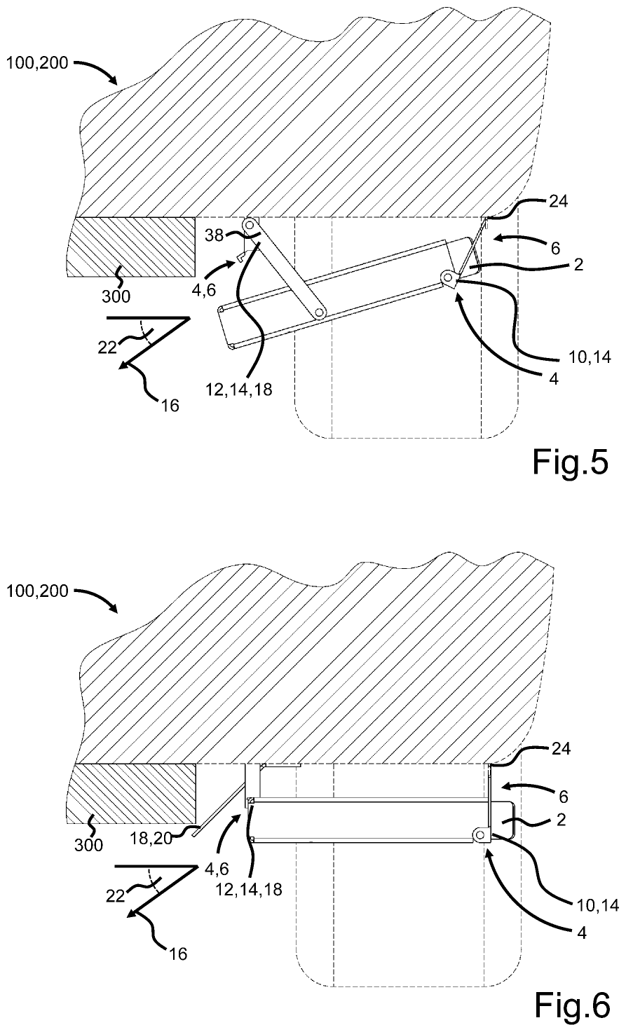

FIG. 5 shows the embodiment shown in FIG. 4 during/after a crash. Projection 26 with bearing surface 28 has been turned inwards by the crash such that projection 26 is out of engagement with step tread 2. The latter therefore swings down and is held by coupling member 38. The path of movement of the step tread is influenced by coupling member 38, as described in FIG. 4. Rod 6 and thus step tread 2 have been partially detached at predetermined bending point 24; after moving out of the original position, step tread 2 continues to be partly held by front holder 10. Path of movement 16 is at an angle to the horizontal, such that step tread 2 is/has been moved past energy storage unit 300.

FIG. 6 shows an embodiment in which, compared to the embodiment shown in FIGS. 4 and 5, a guide face 20 instead of coupling member 38 is provided and arranged obliquely relative to the horizontal in such a way that step tread 2 is diverted and deflected downwards and inwards relative to the vehicle structure 200 in the event of a crash. As in the previous embodiment, projection 26 is designed here in such a way that it is rotatably mounted on a first portion 32 of rear holder 12. Projection 26 forms a notch 30 which opens towards the outer side of the vehicle and has a bearing surface 28 on which step tread 2 rests.

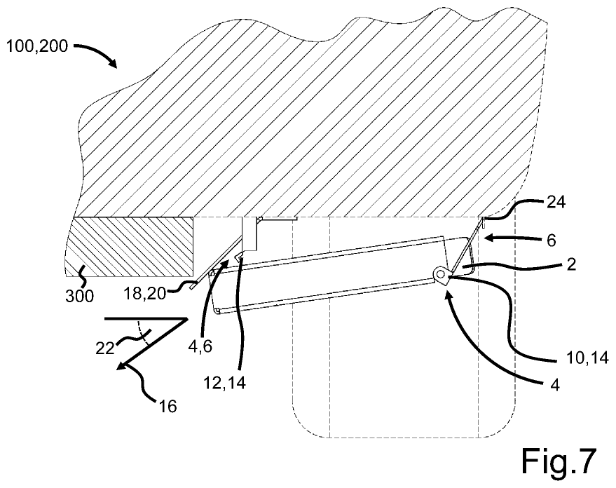

FIG. 7 shows how step tread 2 shown in the embodiment in FIG. 6 is deflected in the event of a crash. Projection 26 with bearing surface 28 is likewise turned inwards such that projection 26 is out of engagement with step tread 2. Step tread 2 is in contact with and deflected by guide face 20.

The embodiments described above are only descriptions of preferred embodiments of the present invention and are not intended to limit the scope of the present invention. Various variations and modifications can be made to the technical solution of the present invention by those of ordinary skills in the art, without departing from the design of the present invention. The variations and modifications should all fall within the claimed scope defined by the claims of the present invention.

1. A step tread holder assembly for a vehicle having a step tread attachable to a vehicle structure of said vehicle, comprising:
a bearing unit for attaching the step tread to the vehicle structure, said bearing unit being designed in such a way that in the event of a crash the step tread can be moved relative to the vehicle structure and/or can be partly or completely detached from the vehicle structure, and
a motion guiding element for influencing a path of movement of the step tread relative to the vehicle structure in the event of a crash,
wherein the bearing unit has at least one front holder which is positioned on the vehicle structure in an outer area of the vehicle, and the bearing unit has at least one rear holder which is positioned on the vehicle structure in an inner area of the vehicle.

2. The holder assembly of claim 1, further comprising:
a deflector for deflecting a movement of the step tread along a path of movement in the event of a crash.

3. The holder assembly of claim 1, wherein the rear holder has a guide for deflecting the step tread.

4. The holder assembly of claim 3, wherein the guide of the rear holder includes guide faces which are arranged obliquely relative to a horizontal in such a way that the step tread is diverted and deflected downwards and inwards relative to the vehicle structure in the event of a crash.

5. The holder assembly of claim 4, wherein the guide faces are arranged in an angular range between 85° and 15° relative to the horizontal.

6. The holder assembly of claim 4, wherein the guide faces are arranged in an angular range 30° and 60° relative to the horizontal.

7. The holder assembly of claim 1, wherein at least one of the bearing unit and the at least one front holder has a predetermined breaking point or a predetermined bending point, such that in the event of a crash the step tread can be moved inwards from the outside in relation to the vehicle structure, the predetermined breaking point or the predetermined bending point being designed in such a way that the step tread can detach itself partly or completely from the vehicle structure.

8. The holder assembly of claim 7, wherein the predetermined breaking point or the predetermined bending point is designed as a component having a definable strength, whose strength is set in such a way that the step tread can release itself from its position when specific accelerating forces arise in the event of a crash.

9. The holder assembly of claim 8, wherein the predetermined breaking point or predetermined bending point is so designed that the step tread continues to be held at least partly by the front holder after moving out of its original position.

10. The holder assembly of claim 4, wherein the rear holder has a projection so as to form a bearing surface for the step tread or an attachment member connected to the step tread.

11. The holder assembly of claim 10, wherein the projection on the rear holder forms a notch, which opens towards the inner side of the vehicle, and that the guide faces of the guide are formed on the holder next to or adjacent to the notch, so as to deflect the step tread inwards and downwards in the event of a crash.

12. The holder assembly of claim 11, wherein the notch is an elongate hole.

13. The holder assembly of claim 1, wherein the rear holder has a first portion extending substantially vertically downwards from the vehicle structure and a second portion extending obliquely inwards on which at least one guide face for deflecting is formed.

14. The holder assembly of claim 1, wherein at least one of the front holder and rear holder has a coupling member, which is pivotably articulated on the vehicle structure and pivotably articulated on the step tread and in the event of a crash deflects the step tread along a path of movement, also with at least a downward component of movement towards the ground, and in so doing supports the step tread.

15. The holder assembly of claim 14, wherein the coupling member is formed on the rear holder and is a coupling rod.

16. The holder assembly of claim 1, wherein the front holder has a holder member which is at least partly plastically deformable and which deforms at least plastically in the event of a crash and also guides the step tread along the path of movement and continues to support the step tread in the event of a crash.

17. The holder assembly of claim 2,
wherein the rear holder has a guide for deflecting the step tread, the guide of the rear holder includes guide faces which are arranged obliquely relative to a horizontal in such a way that the step tread is diverted and deflected downwards and inwards relative to the vehicle structure in the event of a crash,
wherein at least one of the bearing unit and the at least one front holder has a predetermined breaking point or a predetermined bending point, such that in the event of a crash the step tread can be moved inwards from the outside in relation to the vehicle structure, the predetermined breaking point or predetermined bending point being designed in such a way that the step tread can detach itself partly or completely from the vehicle structure,
wherein the rear holder has a projection so as to form a bearing surface for the step tread or an attachment member connected to the step tread, the projection on the rear holder forms a notch, which opens towards the inner side of the vehicle, and that the guide faces of the guide are formed on the holder next to or adjacent to the notch, so as to deflect the step tread inwards and downwards in the event of a crash,
wherein the rear holder has a first portion extending substantially vertically downwards from the vehicle structure and a second portion extending obliquely inwards on which at least one guide face for deflecting is formed,
wherein at least one of the front holder and rear holder has a coupling member, which is pivotably articulated on the vehicle structure and pivotably articulated on the step tread and in the event of a crash deflects the step tread along a path of movement, also with at least a downward component of movement towards the ground, and in so doing supports the step tread, and
wherein the front holder has a holder member which is at least partly plastically deformable and which deforms at least plastically in the event of a crash and also guides the step tread along the path of movement and continues to support the step tread in the event of a crash.

18. A vehicle, comprising:
a vehicle structure,
a drive for the vehicle,
an energy storage unit for the drive of the vehicle,
a step tread which can be attached to the vehicle structure of the vehicle,
a step tread holder assembly for the step tread, and
at least one bearing unit for attaching the step tread to the vehicle structure,
wherein the bearing unit is so designed that in the event of a crash the step tread can be moved relative to the vehicle structure and/or can be detached partly or completely from the vehicle structure, and
the holder assembly has a motion guiding element for influencing a path of movement of the step tread relative to the vehicle structure in the event of a crash.

19. The vehicle of claim 18, wherein the motion guiding element is designed in such a way that in the event of a crash the step tread is guided past the energy storage unit along a path of movement extending at least partially underneath the energy storage unit.

20. The vehicle of claim 19, wherein the vehicle is an electric passenger vehicle, the drive is an electric motor, the energy storage unit is an electric battery or a tank for a liquid or gaseous fuel such as hydrogen, and the step tread holder assembly includes the elements of claim 1.
